(19) United States
(12) Patent Application Publication
(10) Pub. No.: US 2006/0054073 A1
(43) Pub. Date: Mar. 16, 2006

(54) Apparatus and method for reducing vortices in the wake of a marine member

(76) Inventor: Edmund Muehlner, Houston, TX (US)

Correspondence Address: ARNOLD & FERRERA, L.L.P., 2401 FOUNTAIN VIEW DRIVE, SUITE 630, HOUSTON, TX, 77057, US

(21) Appl. No.: 11/087,903

(22) Filed: Mar. 23, 2005

Related U.S. Application Data
(60) Provisional application No. 60/601,353, filed on Aug. 13, 2004.

(51) Int. Cl. F15D 1/10

(52) U.S. Cl. 114/243

(57) ABSTRACT

An apparatus and method for reducing the vortex formation in the wake of a marine member is disclosed, wherein the apparatus comprises a plurality of vortex generators extending perpendicularly from the surface of a marine member, and wherein a chord of the vortex generator is inclined at an angle ranging between 0 degrees and about 40 degrees, measured relative to a fluid flow component described perpendicular to the marine member. A variety of vortex generator configurations, installation angles, size ratios, and methods and means of operation and desirable operational characteristics are also disclosed.

### CROSS-REFERENCE TO RELATED APPLICATIONS

The instant application is a continuation-in-part of prior U.S. Provisional application No. 60/601,353, filed on Aug. 13, 2004.

### FIELD OF THE INVENTION

The present invention relates generally to an apparatus and method for affecting the boundary layer of a fluid flow around a marine member, and in a particular, non-limiting embodiment, to an apparatus and method for affecting the boundary layer of a fluid flow by disposing a plurality of vortex generators on a body portion of said marine member.

### BACKGROUND

Offshore installations frequently comprise marine members that are submerged in water and exposed to surrounding currents and wave action. Pipelines, risers, mooring lines and tendons, and the legs of fixed and compliant platforms, as well as the hulls of floating platforms and vessels (or partial sections thereof), are representative examples of approximately cylindrical and rectangular marine members employed in a wide variety of commercial applications. Typically, the purpose of the marine member is to smoothly transfer loads during operations, or to capture and contain associated physical matter, such as water, carbohydrates, or air.

Those of ordinary skill in the pertinent arts will appreciate that loads imparted on the marine members due to currents and wave action can pose significant problems in the design and maintenance of offshore installations. For example, relative motion between the water and the marine member can cause the formation of vortices in an associated wake, which can in turn subject the marine member to increased drag and dynamic excitation in directions both in-line and transverse to the flow axis. Such loads are generally undesirable, and can, in extreme circumstances, lead to failure of the entire system.

Generally, when a marine member is elastically vibrated by the action of a vortex, the term vortex-induced-vibration (“VIV”) is used to describe the member's movement. However, when the generated mode of vibration due to vortex shedding is effectively the rigid body motion of a drilling platform or a vessel hull, the effect is usually referred to as vortex-induced-motion (“VIM”). In the following specification, no particular distinctions are drawn between VIV and VIM motion, and the term VIV is used throughout to describe both the vibration of elastic members and the rigid body motion of a platform or vessel. In any event, the physical cause of both effects is approximately the same, and the present invention is intended to suppress both VIV and VIM motion caused by generated vortices.

Drag and VIV of marine elements is of special concern in applications where it is impracticable to suppress significant deflection of the member by addition of a physical support, such as a brace, as is the case for deepwater risers and floating platforms anchored by means of a passive mooring system.

In order to reduce the VIV of marine members, a variety of possible solutions, e.g., shrouds, strakes, trip wires, spoiler plates, and fairings, have been employed in various configurations with mixed results. For example, while some of the prior methods are practical for particular applications, no device to date has satisfied the need for the vast majority of offshore applications. One point of significant concern is the cost and complexity required to fabricate, install and operate the vortex control device. Consequently, the only VIV mitigating devices that have found widespread acceptance in the offshore industry include helical strakes.

However, while helical strakes are currently the preferred choice for reduction of VIV in marine members, their global efficacy is highly questionable. Moreover, improved VIV behavior due to strakes can unintentionally lead to an increase in drag. For a floating deepwater platform, the cost penalty of such drag increases can amount to millions of dollars.

The root cause of vortex formation in the wake of a body is the loss in momentum of the flow medium in close proximity to the body surface (the so-called “boundary layer”). When a fluid flows along the surface of a body, energy is dissipated in the boundary layer due to fluid viscosity. The local velocity of the fluid then decreases until the flow in the boundary layer reverses direction, thereby initiating a vortex that increases in size so long as it is fed by energy from the primary flow.

Once a vortex has developed to a certain size, it is washed downstream, where it ultimately dissipates. The process described above repeats periodically, causing the periodic shedding of vortices and the formation of a steady stream of vortices in the wake of the body.

At the location of the body where the vortices are being formed, the stream of the primary fluid flow becomes separated from the body. The result of that flow separation is formation of a low-pressure region on the downstream side of the body, which causes a load effect on the body usually referred to as pressure drag. Since the pressure field is periodically fluctuating, the marine member will at some point become dynamically excited, a condition that leads to further inducement of vortex-induced vibrations.

In addition to marine-specific applications, vortex generators are commonly found on aircraft, in power plants, and many other technical devices utilizing fluid flows. Typical applications include diverging diffusers, curved air vents, turbine blades, and airfoils. Some use of vortex generators for marine applications are shown in prior U.S. Pat. No. 4,825,795 to Slemmons, U.S. Pat. No. 6,665,311 to Kondylis, et al., and U.S. Pat. No. 5,887,280 to Waring.

### SUMMARY OF THE INVENTION

The present invention comprises an apparatus and method for reducing vortices in the wake of marine members by affecting the boundary layer of an associated flow. Reduction of both drag and VIV is achieved by disposing one or more vortex generators on the surface of the body. In a presently preferred embodiment, the vortex generators are small, wing-like devices inclined at a predetermined angle relative to the flow direction. Due to the inclined angle, each vortex generator produces a small circulation field with an axis of rotation approximately parallel to the flow direction. The circulation field re-energizes the boundary layer by mixing a higher velocity flow in the primary stream with a lower velocity flow in the boundary layer. Due to the re-energizing of the boundary layer, the point of flow separation shifts further downstream or, in optimal circumstances, is completely avoided. A variety of vortex generator configurations, installation angles, size ratios, and methods and means of operation and desirable operational characteristics are also disclosed.

### BRIEF DESCRIPTION OF DRAWINGS

FIG. 1 is an elevated view of a marine member comprising a plurality of vortex generators according to the invention.

FIG. 2 is a top view of the marine member of FIG. 1, further depicting the scale and chord of the vortex generators.

FIG. 3 is an enlarged section of FIG. 1, showing a side profile of a vortex generator according to the invention.

FIG. 4 is an enlarged section of FIG. 1, showing an alternative side profile of a vortex generator according to the invention.

FIG. 5 depicts a vortex generator extending from the surface of a marine member, and further depicting the circulation field generated by the vortex generator.

### DETAILED DESCRIPTION OF THE INVENTION

The present invention comprises disposition of one or more vortex generators on a marine member so that fluid flow in the boundary layer of the member is altered, thereby reducing drag load, and reducing (or eliminating altogether) vortices and vortex-induced vibrations. In a presently preferred embodiment of the invention, the desired effect is achieved by attaching a plurality of vortex generators to the surface of a marine member in either a uniform array or in an irregular pattern. A significant advantage of the invention is the relatively simple manner in which the vortex generators can be applied to the hulls of vessels or floating platforms with relatively low construction cost and installation effort. Moreover, as one of ordinary skill in the art will appreciate, the total cost savings for an entire floating platform due to the benefits of drag reduction can be significant.

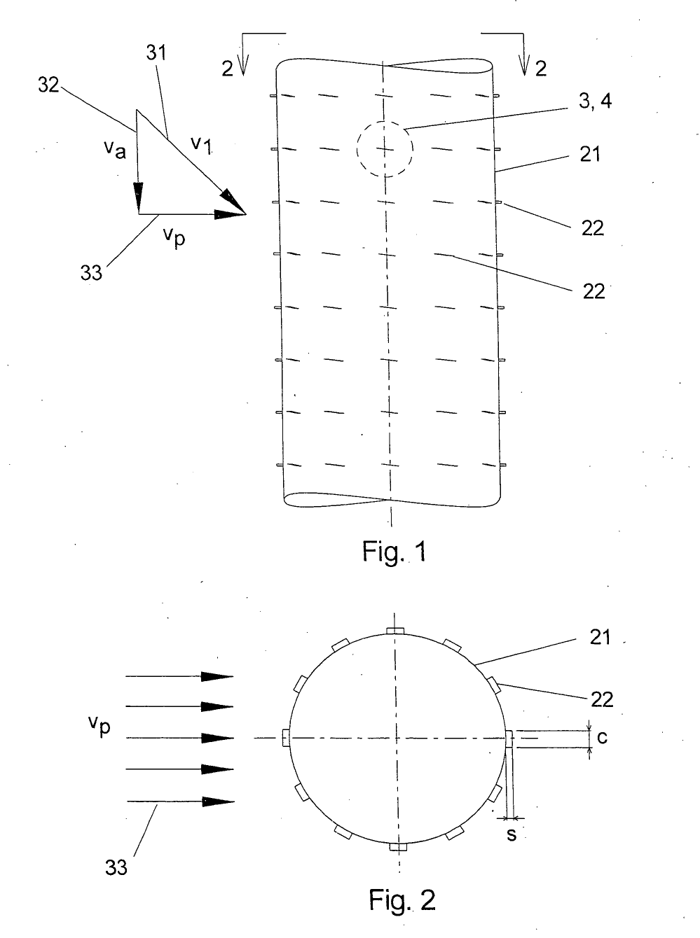

Referring now to FIG. 1, a generic submerged marine member 21 is depicted, disposed in this instance in an elevated view. FIG. 2 shows the same marine member in top view. In order to reduce the formation of vortices in the wake according to the invention, a plurality of vortex generators 22 are disposed upon the surface of marine member 21. As depicted, marine member 21 appears to be approximately cylindrical in shape, but those of ordinary skill in the art will appreciate that marine member 21 may also be of any other shape, e.g., approximately ovoid, rectangular, irregular in shape, etc., without departing from either the scope or spirit of the present invention.

When a vortex generator 22 disposed upon marine member 21 is exposed to a fluid flow having a velocity V₁ 31, the fluid flow is composed of discrete directional components, viz., a flow component parallel to the vortex generator's longitudinal axis Vₐ 32, and a flow component perpendicular to the member's longitudinal axis Vₚ 33. It is the perpendicular flow component Vₚ 33 that causes vortex shedding in the wake of the marine member.

The vortex generators 22 are small, wing-like sections mounted to the surface of the body. Any known methods and means of affixing the vortex generators 22 to the marine member 21 will suffice, provided that the means of affixation will not significantly interfere with the fluid dynamics required for the efficacy of the present invention.

The relative distance a given vortex generator 22 extends out from the surface of marine member 21 is called the span s. The dimension from the fore to the aft of the vortex generator is defined as the chord c. The ratio of span to chord is called the aspect ratio. A representative, though non-limiting, embodiment of a marine member equipped with a plurality of vortex generators 22, each having a span s and a chord c, is depicted in FIG. 2.

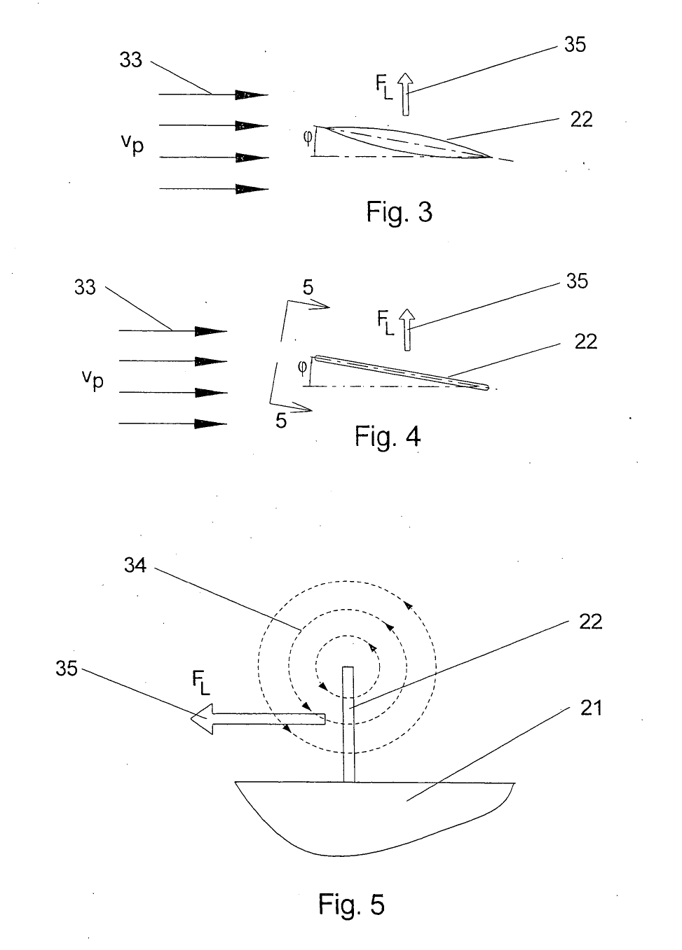

When the chord of vortex generator 22 is inclined by an angle φ relative to the perpendicular flow Vₚ 33, a lifting force F_{L} 35 is generated together with a circulation field. FIGS. 3 and 4 depict various representations of the chord angle φ and two possible cross sections of the vortex generator 22. In a presently preferred embodiment, a chord of the vortex generator is inclined by an angle φ ranging between 0 degrees and about 40 degrees, measured relative to a fluid flow component described perpendicular to the marine member. Of course, other chord angles and vortex generator profiles can be employed without necessarily affecting the efficacy of the claimed device.

Referring now to the example embodiment of FIG. 5, a vortex generator 22 and a generated circulation field 34 (indicated by dashed circles) are shown. The chord angle φ is defined such that φ is equal to zero at the position where the generated lift force F_{L} 35 and the corresponding circulation 34 are both zero. The beneficial effect of the vortex generator 22 comes from the circulation field 34, with the lift force F_{L} 35 being merely a by-product. Consequently, it does not matter in which direction the lift force F_{L} points 35, provided an effective circulation field 34 is generated.

A given vortex generator 22 will usually work best with low aspect ratios and a span approximately equal to the thickness of the boundary layer of the flow. A plurality of vortex generators 22 may be disposed about the body of a marine member 21 in regular patterns (as shown in FIGS. 1 and 2), or they may be disposed in irregular arrangements on the surface of marine member 21, as dictated by a particular operational environment. The precise materials used to create the vortex generators, as well as the methods and means employed to affix the members to a marine member, can vary according to the demands of the project.

The foregoing specification is provided for illustrative purposes only, and is not intended to describe all possible aspects of the present invention. Moreover, while the invention has been shown and described in detail with respect to several exemplary embodiments, those of ordinary skill in the pertinent arts will appreciate that minor changes to the description, and various other modifications, omissions and additions may also be made without departing from either the spirit or scope thereof.

1. An apparatus for reducing vortices in the wake of a marine member, said apparatus comprising:
a marine member; and
a vortex generator disposed on a body portion of said marine member.

2. The apparatus of claim 1, wherein a plurality of vortex generators are disposed on a body portion of said marine member in a uniform array.

3. The apparatus of claim 1, wherein a plurality of vortex generators are disposed on a body portion of said marine member in an irregular pattern.

4. The apparatus of claim 1, wherein said vortex generator is formed in an approximately winged shape.

5. The apparatus of claim 1, wherein the greatest distance said vortex generator protrudes outward from said body portion of said marine member is defined by a span measurement.

6. The apparatus of claim 5, wherein said span measurement is approximately equal to a thickness of a boundary layer of surrounding fluid flow.

7. The apparatus of claim 1, wherein the greatest distance between a fore point and an aft point of said vortex generator is defined by a chord measurement.

8. The apparatus of claim 7, wherein a chord of said vortex generator is disposed at a predetermined angle measured relative to a fluid flow component described perpendicular to said marine member.

9. The apparatus of claim 8, wherein said predetermined angle is between zero degrees and about forty degrees.

10. The apparatus of claim 8, wherein said predetermined angle is greater than about forty degrees.

11. A method of reducing vortices in the wake of a marine member, said method comprising:
disposing a marine member in communication with an associated fluid flow; and
disposing a vortex generator on a body portion of said marine member.

12. The method of claim 11, further comprising disposing a plurality of vortex generators on a body portion of said marine member in a uniform array.

13. The method of claim 11, further comprising disposing a plurality of vortex generators on a body portion of said marine member in an irregular pattern.

14. The method of claim 11, further comprising disposing a vortex generator having an approximately winged shape.

15. The method of claim 11, further comprising establishing a greatest distance that said vortex generator protrudes outward from said body portion of said marine member as a span measurement.

16. The method of claim 15, further comprising establishing a maximum span measurement that is approximately equal to a thickness of a boundary layer of surrounding fluid flow.

17. The method of claim 11, further comprising establishing an extreme distance between a fore point and an aft point of said vortex generator as a chord measurement.

18. The method of claim 17, further comprising disposing a chord of said vortex generator at a predetermined angle measured relative to a fluid flow component described perpendicular to said marine member.

19. The method of claim 18, further comprising disposing a chord of said vortex generator at a predetermined angle of between zero degrees and about forty degrees.

20. The method of claim 18, further comprising disposing a chord of said vortex generator at a predetermined angle greater than about forty degrees.
